(19) United States
(12) Patent Application Publication
(10) Pub. No.: US 2006/0286525 A1
(43) Pub. Date: Dec. 21, 2006

(54) Wearable breast examination training apparatus

(76) Inventor: Lindsay Kim Haines, Marietta, GA (US)

Correspondence Address: WALTER T. KIM, SUITE 1300, 2030 MAIN STREET, IRVINE, CA, 92614, US

(21) Appl. No.: 11/136,880

(22) Filed: May 25, 2005

(51) Int. Cl. G09B 23/28

(52) U.S. Cl. 434/267

(57) ABSTRACT

A training device used to teach self breast exam techniques includes a garment to be worn by a user, which is used to support a pair of breast simulating members on the chest area of the user. Embedded within the breast simulating members are simulated breast lumps to simulate human breast structures with cancerous lumps or other abnormalities.

### BACKGROUND OF THE INVENTION

1. Field of the Invention

The present invention generally relates to breast examination training devices.

2. Description of the Related Art

Breast cancer, the second leading cause of cancer death in American women, is a growing epidemic. More than two hundred thousand women each year find they have breast cancer, while over forty thousand die. Five percent of these patients are women under forty. Many believe that women under forty do not get breast cancer; this myth comes largely from lack of research and funding for breast cancer patients under forty, a group with unusually aggressive cancer cells. Training systems adapted to target women under forty will eventually lead to decreased breast cancer death rates. Young women need proper training on detection in order to increase the chance of early detection. Early detection is the most effective way to survive cancer. Women who experience stage zero to stage two carcinomas have a better chance surviving than women with stage three and higher carcinomas. Unfortunately, women under forty often do not get the opportunity to detect cancer early because of lack of testing. Further, because young women's breasts tend to be dense and full of milk glands, mammograms may be more difficult to interpret. Unfortunately, local mammography centers lack most alternative testing methods. Therefore, the breast self-examination may be the only alternative that allows early detection in young women. Utilizing the self breast exam once a month helps young women detect cancer in its early stages. According to experts, young women are at a higher risk of late detection because breast tumors may grow more aggressively in younger women. Most lumps found during self exams are not cancerous, but when cancerous lumps are found early, survival rate increases dramatically.

Accordingly, there is a need to provide a training device that can be used by women, including young women under forty, to familiarize themselves with how breast lumps feel during breast examination.

### BRIEF SUMMARY OF EMBODIMENTS THE INVENTION

Described herein are various embodiments of a wearable breast examination training device for teaching users to familiarize themselves with how breast lumps feel during breast self-examination. The training device includes at least one simulated breast structure and a supporter to support the at least one simulated breast structure on the body of a user. In one embodiment, the supporter is configured to support a pair of simulated breast structures on the chest area of a user. Embedded within each of the simulated breast structures is a simulated breast lump to simulate a human breast with a cancerous lump or other abnormalities.

According to an embodiment, the training device includes a garment to be worn by a user. The garment is configured to support a pair of breast simulating members on the chest area of the user. In an embodiment, the breast simulating members supported by the garment is interchangeable in order to allow the user to experience breast tumors of various sizes, densities and locations within the breast simulated structure. In an embodiment, pockets are formed in a garment to removably hold the breast simulating members. The pockets may be formed of an elastic material, such as an elastic fabric, to firmly hold the breast simulating members. In an embodiment, at least a portion of the pockets are made of a thin elastomeric material to simulate human skin covering the underlying simulated human breast structure.

According to an embodiment, the breast examination training device allows the user to practice performing breast self-examination in various positions, including while the user is in an upright position and while the user is a lying down position. This way the user can experience how the tumor simulating elements contained with in the simulated breast structure may feel in both standing and lying down positions. Additionally, because the breast simulating members are positioned is the chest area of the user, the training device advantageously affords a more realistic learning experience by enabling the user to apply breast examination techniques in the same hand and arm positions as when performing an actual breast self-examination.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 is a diagrammatic perspective view of a wearable breast examination training device according to an embodiment of the present invention.

FIG. 2 is a diagrammatic perspective view of an embodiment of a wearable breast examination training device having pockets formed in a garment to removably hold breast simulating members.

FIG. 3 is a diagrammatic perspective view of an embodiment of a wearable breast examination training device, in which at least a portion of pockets is formed of elastomeric polymer material.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known structures and techniques have not been shown in detail in order to avoid obscuring embodiments of the present invention. It should be noted that, as used in the description herein and the claims, the meaning of “in” includes “in” and “on”.

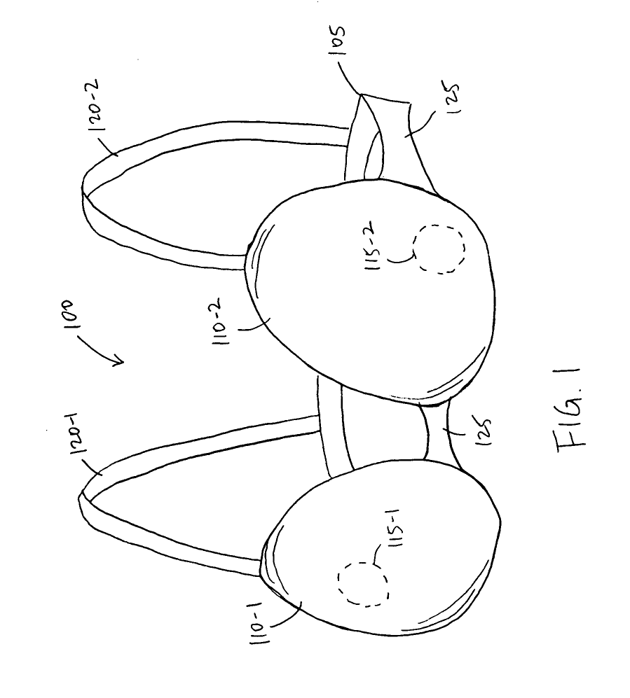

FIG. 1 shows a wearable breast examination training device 100 according to an embodiment of the present invention. The training device 100 may be worn by a user and used to familiarize oneself with how cancerous lumps feel during breast self-examination. The training device 100 includes a supporter 100 to support a pair of breast simulating members 110-1, 110-2 on the chest area of a user. The breast simulating members 110 are configured to simulate human breasts with cancerous lumps 115-1, 115-2 or other abnormalities. The supporter 100 may utilize a chest strap 125 and/or shoulder straps 120-1, 120-2 to properly secure the training device 100 on the user.

In one embodiment, the breast simulating members 110 is permanently fixed to the supporter 105. The breast simulating members 110 may be made of any material which can closely simulate physical characteristics (e.g., density) of an actual human breast, such as, for example, rubber, silicon, silicon rubber, silicon rubber gel or the like. Embedded within the breast simulating members 110 are one or more cancerous lump simulating elements 115-1, 115-2, which have density different from the density of the breast simulating member 110 to simulate the feel of actual breast lumps. The tumor simulating elements 115 may be made of any material which can closely simulate physical characteristics (e.g., density) of an actual breast tumor, such as, for example, rubber, silicon rubber or the like.

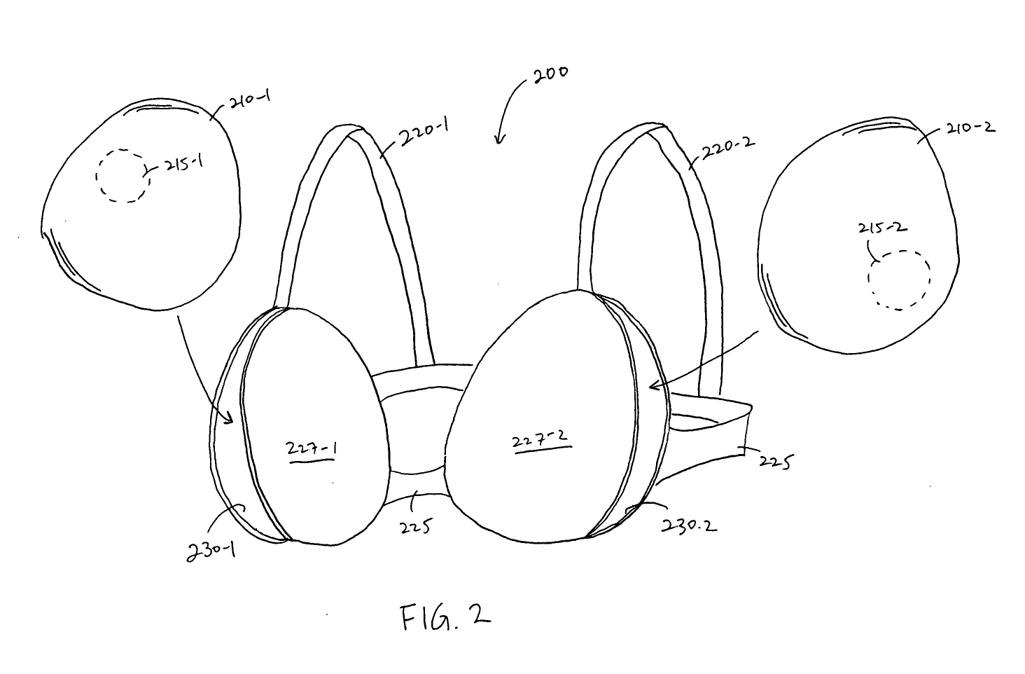

In another embodiment, the wearable training device is configured to enable a user to interchange breast simulating members so that the user can experience breast lumps which are present in various sizes, densities and locations within the breast simulated structure. One example of a wearable training device 200 supporting interchangeable breast simulated structures in shown in FIG. 2. In one embodiment, a garment, such as a brassiere-type garment, is utilized to support the breast simulating members 210-1, 210-2 on the user's body. The brassiere-type garment may include a chest strap 225 and/or shoulder straps 220-1, 220-2.

In one embodiment, pockets are formed in the garment to removably receive the breast simulating members 210-1, 210-2. Each of the pockets may be provided with an access opening 230-1, 230-2 to facilitate insertion of the breast simulating members 210-1, 210-2. The pockets may be formed from an elastic fabric, which may be joined by stitching or bonding along their peripheral edges thereof. It should be noted that any other suitable methods and techniques may be employed to facilitate detachably attaching the breast simulating members to the garment.

The wearable training device 200 may be supplied with a number of breast simulating members 210, which vary in terms of density, size and shape, so that the training device is applicable to women of various age groups and physical characteristics. The density, size and shape of tumor simulating elements 215-1, 215-2 embedded within breast simulating members 210 may also vary to enable a user to familiarize oneself with how various breast lumps feel during self breast exam. Further, the tumor simulating elements 215 may be positioned at various locations within the breast simulating members 210. For example, the tumor simulating members 210 may be located near the body surface or located deep within the breast simulating member where it is more difficult to detect. This way the device 200 can be used to teach self breast exam techniques for detecting tumors located in more difficult locations. In one implementation, a tumor simulating element is positioned within a breast simulating member such that the tumor simulating element is detectable by performing self breast exam while the user is in only one of an upright position or in a lying down position.

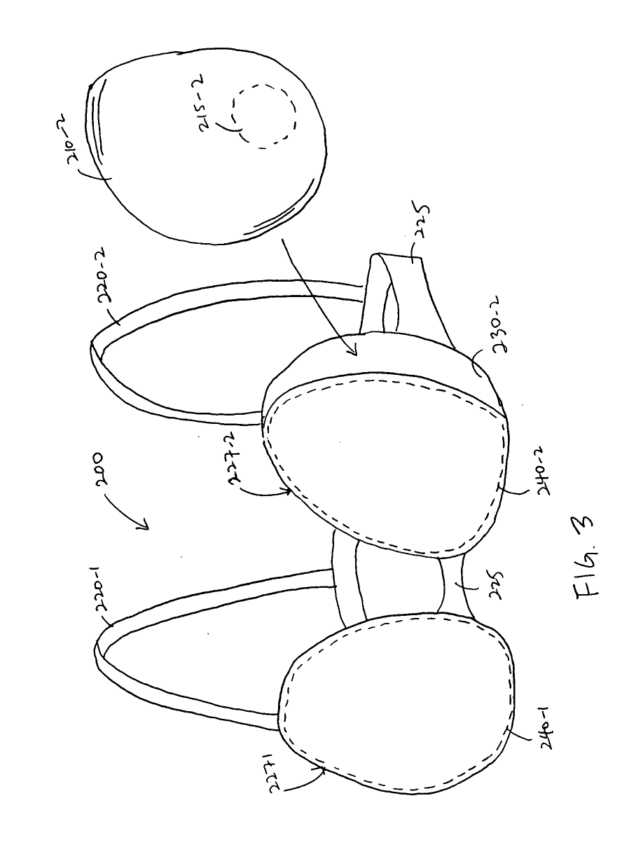

FIG. 3 shows another embodiment of a wearable training device 200 in which at least a portion of the layers forming the pockets 227 is made of a simulated skin layer 240-1, 240-2 to simulate human skin covering the underlying simulated human breast structure. The simulated skin layer 240-1, 240-2 may be a thin elastomeric section made of elastomeric polymer material that resembles a human skin.

In use, the breast examining training device is worn over the user's clothing such that the breast simulating members are positioned on the chest area of the user. Once the training device has been properly worn, the user can apply various breast self-examination techniques to examine the breast simulating members and to familiarize herself with how breast lumps feel during self breast exam. Embodiments of the present invention provide a number of advantages over the existing breast examination training tools. Because the breast simulating members are positioned on the chest area of the user, the training device advantageously affords a more realistic learning experience by enabling the user to apply self breast exam techniques in the same hand and arm positions as when performing actual breast self-examination. Moreover, the training device can also advantageously teach the user to practice performing breast self-examination while standing as well as while lying down. Another advantage is that because the training device 100, 200 may be perceived as being more entertaining than conventional breast examining training tools, the training device may be more effective in encouraging more young women to learn self breast exam techniques.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. An apparatus comprising:
at least one simulated breast structure;
a supporter to support the at least one simulated breast structure on body of a user; and
at least one simulated breast lump element embedded within the simulated breast structure, wherein the simulated breast lump element has a density different from the simulated breast structure.

2. The apparatus of claim 1, wherein the supported configured to support the at least one simulated breast structure on chest area of the user.

3. The apparatus of claim 1, further comprising at least one holder coupled to the supporter to facilitate detachably attaching the at least one simulated breast structure to the supporter.

4. The apparatus of claim 1, wherein the supporter comprises a brassiere-type garment having a chest strap and a pair of shoulder straps.

5. The apparatus of claim 4, wherein the supporter includes at least one pocket to removably hold the at least one simulated breast structure.

6. The apparatus of claim 5, wherein at least a portion of the pockets is made of an elastic fabric.

7. The apparatus of claim 5, wherein at least a portion of the pockets includes an elastomeric section simulating a skin layer covering the underlying simulated breast structure.

8. The apparatus of claim 1, wherein the at least one simulated breast structure is permanently fixed the supporter.

9. The apparatus of claim 1, wherein the simulated breast lump element is positioned within the simulated breast structure such that the simulated breast lump element is detectable by performing self breast exam while the user is in only one of an upright position or in a lying down position.

10. A method comprising:
providing at least one breast simulating member having a tumor simulating element embedded therein;
positioning the at least one breast simulating member on chest area of a user; and
examining the at least one breast simulating member by the user to familiarize oneself user with how a breast tumor feels.

11. The method of claim 10, further comprising:
using a garment to position the at least one breast simulating member on the chest area of the user, wherein the garment is worn over a clothing of the user.

12. The method of claim 11, further comprising:
removing the at least one breast simulating member from the garment; and
inserting a different breast simulating member in the garment.

13. The method of claim 10, further comprising:
performing examination of the at least one breast simulating member while the user is in an upright position.

14. The method of claim 10, further comprising:
performing examination of the at least one breast simulating member while the user is in a lying down position.

15. A breast examination training device comprising:
a garment to be worn by a user;
a pair of breast simulating members coupled to the garment; and
at least one tumor simulating element included in at least one of the breast simulating members, wherein the tumor simulating element has a density different from the breast simulating member.

16. The breast examination training device of claim 15, wherein the breast simulating members are positioned on chest area of the user when the garment is worn by the user.

17. The breast examination training device of claim 15, wherein the breast simulating members are shaped to resemble a human breast.

18. The breast examination training device of claim 15, wherein the breast simulating members are formed of a material to simulate a density of a human breast.

19. The breast examination training device of claim 15, wherein the tumor simulating element is shaped to resemble a breast tumor.

20. The breast examination training device of claim 15, wherein the tumor simulating element is formed of a material to simulate a density of a breast tumor.

21. The breast examination training device of claim 15, wherein the garment includes holders to removably hold the breast simulating members.

22. The breast examination training device of claim 21, wherein the holders comprises pockets formed in the garment to removably receive the breast simulating members.

23. The breast examination training device of claim 22, wherein at least a portion of the pockets is made of an elastic fabric.

24. The breast examination training device of claim 22, wherein at least a portion of the pockets includes an elastomeric section simulating an outer skin layer of the underlying breast simulating member.

25. The breast examination training device of claim 15, wherein the breast simulating members are permanently attached to the garment.
